(19) United States
(12) Patent Application Publication
(10) Pub. No.: US 2004/0155169 A1
(43) Pub. Date: Aug. 12, 2004

(54) Commemorative memorial flag holder

(76) Inventor: Steven Venick, Baltimore, MD (US)

Correspondence Address: DORSEY & WHITNEY LLP, 1001 PENNSYLVANIA AVENUE, N.W., SUITE 400 SOUTH, WASHINGTON, DC, 20004, US

(21) Appl. No.: 10/634,787

(22) Filed: Aug. 6, 2003

Related U.S. Application Data
(63) Continuation-in-part of application No. 29/175,800, filed on Feb. 12, 2003.

(51) Int. Cl. F16M 13/00

(52) U.S. Cl. 248/519

(57) ABSTRACT

A flag holder, either free-standing or attached to a surface. The commemorative memorial flag holder is designed to easily adhere to cemetery monuments. The commemorative flag holder may have double stick adhesive on the back to adhere to cemetery monuments. The commemorative memorial flag holder with a flat bottom is made for foot-stones or to be placed on the base of cemetery monuments. The commemorative memorial flag holder with a flat bottom may have a double stick adhesive on the bottom to adhere to foot-stones or the base of cemetery monuments.

### CROSS-REFERENCE TO RELATED APPLICATION

This application is a continuation-in-part of and claims priority to U.S. Design application Ser. No. 29/175,800, filed Feb. 12, 2003, entitled “Commemorative Memorial Flag Holder.” The Design Application is incorporated by reference herein in its entirety.

### FIELD OF THE INVENTION

The present invention relates to gravesite ornaments, and more particularly to flag holders for gravesites.

### BACKGROUND OF THE INVENTION

The adorning of gravesites with ornamentation is common. Often, small flags are placed on or near headstones. These flags may be placed temporarily on the headstone for particular occasions, such as Memorial Day or Veterans' Day, or may be more permanently attached to the headstone for a longer period of time. Flags are often sunk into the ground near the headstone, where they may become dirty or may be accidentally broken.

### SUMMARY

The embodiments described herein overcome the disadvantages of the prior art. The embodiments include a commemorative memorial flag holder, either free-standing or attached to a surface. An embodiment of the commemorative memorial flag holder is designed to easily adhere to cemetery monuments. The commemorative flag holder may have double stick adhesive on the back to adhere to cemetery monuments. Another embodiment of the commemorative memorial flag holder includes a flat bottom and is made for foot-stones or to be placed on the base of cemetery monuments. The commemorative memorial flag holder with a flat bottom may have a double stick adhesive on the bottom to adhere to foot-stones or the base of cemetery monuments.

### BRIEF DESCRIPTION OF THE DRAWINGS

The features, aspects, and advantages of the present invention will become better understood with regard to the following description, appended claims, and accompanying drawings where:

FIG. 1 is a front, left side perspective view of the commemorative memorial flag holder;

FIG. 2 is a front view of the commemorative memorial flag holder;

FIG. 3 is a side view of the commemorative memorial flag holder;

FIG. 4 is a back view of the commemorative memorial flag holder;

FIG. 5 is a top view of the commemorative memorial flag holder;

FIG. 6 is a front, left side perspective view of an alternative embodiment of the commemorative memorial flag holder with a flat bottom;

FIG. 7 is a front view of the alternative embodiment commemorative memorial flag holder with a flat bottom;

FIG. 8 is a side view of the alternative embodiment commemorative memorial flag holder with a flat bottom;

FIG. 9 is a back view of the alternative embodiment commemorative memorial flag holder with a flat bottom; and

FIG. 10 is a top view of the alternative embodiment commemorative memorial flag holder with a flat bottom.

### DETAILED DESCRIPTION OF THE DRAWINGS

The following detailed description is presented to enable any person skilled in the art to make and use the invention. For purposes of explanation, specific nomenclature is set forth to provide a thorough understanding. However, it will be apparent to one skilled in the art that these specific details are not required. Descriptions of specific applications are provided only as representative examples. Various modifications to the preferred embodiments will be readily apparent to one skilled in the art, and the general principles defined herein may be applied to other embodiments and applications without departing from the scope. The present invention is not intended to be limited to the embodiments shown, but is to be accorded the widest possible scope consistent with the principles and features disclosed herein.

An embodiment of the commemorative memorial flag holder is designed to easily adhere to cemetery monuments. The commemorative flag holder may have double stick adhesive on the back to adhere to cemetery monuments. Another embodiment of the commemorative memorial flag holder includes a flat bottom, and is made for foot-stones or to be placed on the base of cemetery monuments. The commemorative memorial flag holder with a flat bottom may have a double stick adhesive on the bottom to adhere to foot-stones or the base of cemetery monuments.

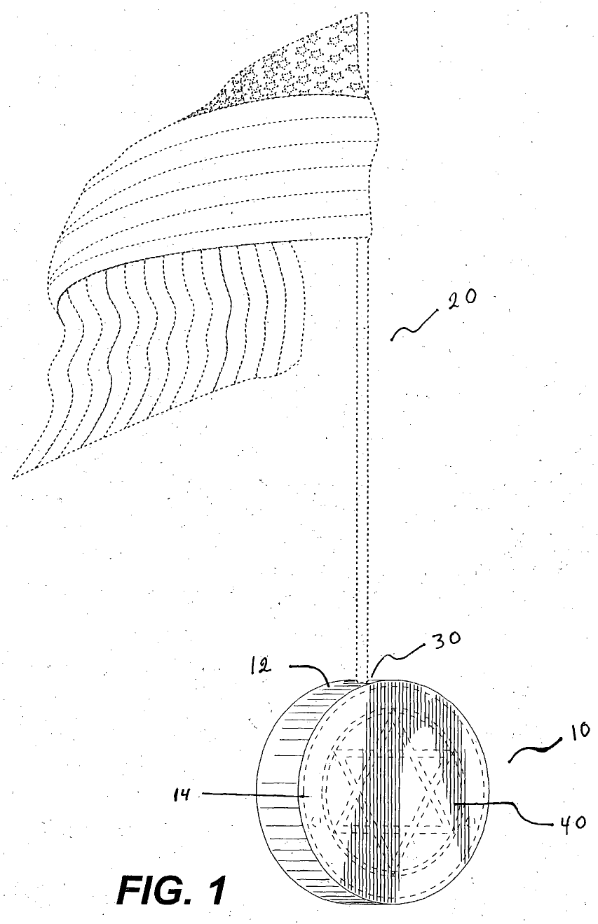

With reference now to FIG. 1, there is shown a front, left side perspective view of the commemorative memorial flag holder, generally designated by the reference numeral 10, showing the commemorative memorial flag holder 10 with a flag 20 that is inserted into a hole 30 defined by a top 12 of the commemorative memorial flag holder 10. Alternatively, the hole 30 may be defined anywhere on the commemorative memorial flag holder 10 including on a side and may extend through the commemorative memorial flag holder 10. The commemorative memorial flag holder 10 preferably includes an exemplary logo or design 40 placed, e.g., on a front side 14 of the commemorative memorial flag holder 10. The commemorative memorial flag holder 10 shown is a round, disc-shaped holder made from ceramic, resin, stone, or other suitable material. The commemorative memorial flag holder 10 may be a different shape, such as square, rectangular, oval, polygonal, star-shaped, or irregularly-shaped. The commemorative memorial flag holder 10 preferably holds the pole of the flag 20 upright, although the flag 20 may be tilted from vertical. The exemplary logo or design 40 shown in FIG. 1 preferably indicates a commemorative or memorial meaning. It should be understood that the design 40 shown may be substituted by any other desirable logo or design or may be blank.

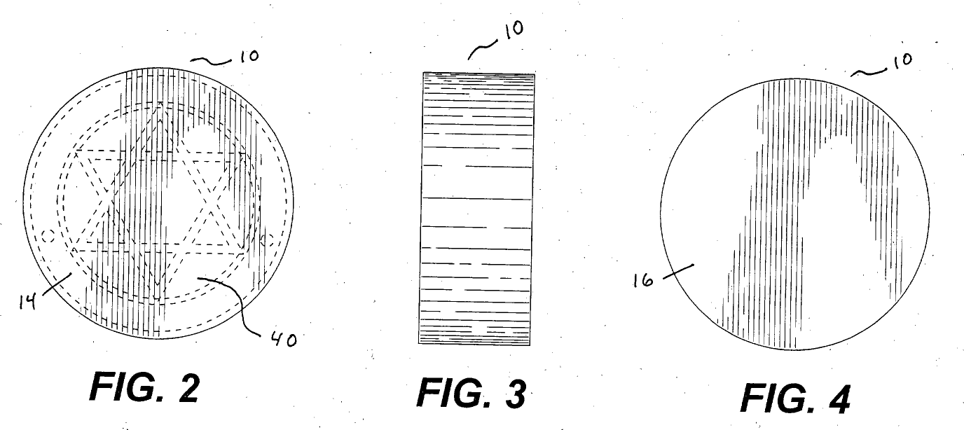

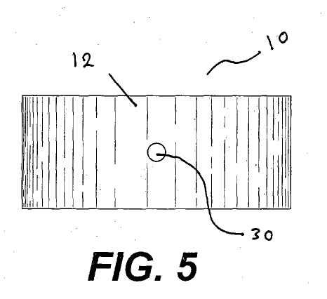

With reference now to FIGS. 2-5, there are shown various views of the commemorative memorial flag holder 10. In FIG. 2, there is a front view of the commemorative memorial flag holder 10, showing the commemorative memorial flag holder 10 with an exemplary logo or design 40 that may be placed on the front side 14 of the commemorative memorial flag holder 10. FIG. 3 shows a side view of the commemorative memorial flag holder 10. In FIG. 4, there is a rear view of the commemorative memorial flag holder 10 showing a back 16 of the commemorative memorial flag holder 10. An adhesive, such as double-stick adhesive or glue, or other temporary or permanent adhesive, may be applied to the back 16 of the commemorative memorial flag holder 10 as shown in FIG. 4. The back of the commemorative memorial flag holder 10, therefore, preferably contacts another surface, e.g., a tombstone, memorial, etc., and is attached, temporarily or permanently, to the surface. FIG. 5 shows a top view of the commemorative memorial flag holder 10, showing the hole 30 in the top 12 for the flag 20 to rest in.

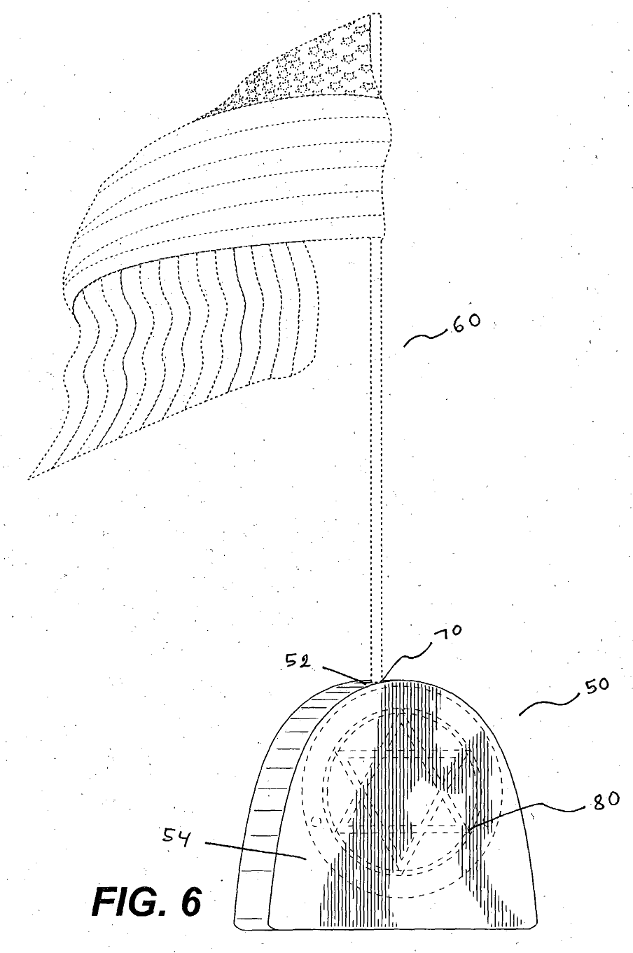

With reference now to FIG. 6, there is shown a front, left side perspective view of an alternative embodiment of the commemorative memorial flag holder with a flat bottom, generally designated by the reference numeral 50, showing the commemorative memorial flag holder 50 with a flag 60 that is inserted into a hole 70 in a top 52 of the commemorative memorial flag holder 50 and an exemplary logo or design 80 that may be placed on a front side 54 of the commemorative memorial flag holder 50. Alternatively, the hole 70 may be defined anywhere on the commemorative memorial flag holder 50 including on a side and may extend through the commemorative memorial flag holder 50. The commemorative memorial flag holder 50 shown is a disc-shaped holder with a flat bottom made from ceramic, resin, stone, or other suitable material. The commemorative memorial flag holder 40 may be a different shape, such as square, rectangular, oval, polygonal, star-shaped, or irregularly-shaped. The commemorative memorial flag holder 50 preferably holds the pole of the flag 60 upright, although the flag 66 may be tilted from vertical.

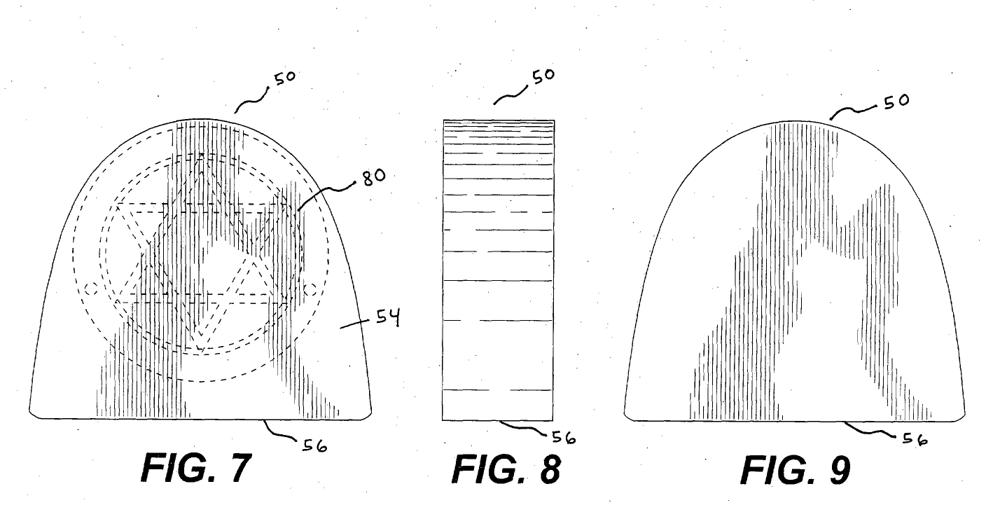

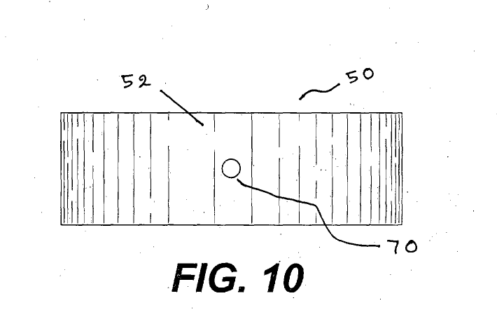

With reference now to FIGS. 7-10, there are shown various views of the commemorative memorial flag holder 50. In FIG. 7, there is a front view of the alternative embodiment commemorative memorial flag holder 50 with a flat bottom 56, showing the commemorative memorial flag holder 50 with an exemplary logo or design 80 that may be placed on the front 54 of the commemorative memorial flag holder 50. An adhesive, such as double-stick adhesive or glue, or other temporary or permanent adhesive, may be applied to the bottom 56 of the commemorative memorial flag holder 50. Alternatively, the commemorative memorial flag holder 50 may be free-standing. The bottom 56 of the commemorative memorial flag holder 50, therefore, preferably contacts another surface, e.g., a base of a footstone, memorial, etc., and may rest on the surface or be attached, temporarily or permanently, to the surface. FIG. 8 shows a side view of the commemorative memorial flag holder 50 with the flat bottom 56. In FIG. 9, there is a back view of the commemorative memorial flag holder 50 with the flat bottom 56. FIG. 10 shows a top view of the commemorative memorial flag holder 50, showing the hole 70 in the top 52 for the flag 60 to rest in.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

I claim:

1. A commemorative memorial flag holder comprising:
a body, having a front side, a rear side, a top side and a bottom side, wherein the top side defines a hole, contoured to hold a flagpole; and
a design located on the front side.

2. The commemorative memorial flag holder of claim 1, wherein the body is disc-shaped.

3. The commemorative memorial flag holder of claim 1, wherein the body has a shape which is selected from the group of shapes consisting of square, rectangular, oval, polygonal star, and irregular.

4. The commemorative memorial flag holder of claim 1, wherein the design is commemorative.

5. The commemorative memorial flag holder of claim 1, wherein the design is memorial.

6. The commemorative memorial flag holder of claim 1, wherein the body comprises a material selected from the group consisting of ceramic, resin, and stone.

7. The commemorative memorial flag holder of claim 1, wherein the rear side of the body has an adhesive which attaches to a surface.

8. The commemorative memorial flag holder of claim 7, wherein the adhesive is selected from the group consisting of glue and double-stick adhesive.

9. The commemorative memorial flag holder of claim 1, wherein the bottom side of the body is flat, and the commemorative memorial flag holder sits with the bottom side resting on a flat surface.

10. The commemorative memorial flag holder of claim 9, wherein the bottom side of the body has an adhesive which attaches to a surface.

11. The commemorative memorial flag holder of claim 10, wherein the adhesive is selected from the group consisting of glue and double-stick adhesive.

12. A commemorative memorial flag holder comprising:
a base portion in a disc-shape, having a front side, a rear side, a top side and a bottom side, wherein the top side defines a hole that holds a flag when in use;
a design located on the front side of the base portion; and
an attaching portion locating on the rear side of the base portion.

13. The flag holder of claim 12, wherein the base portion comprises a material selected from the group consisting of ceramic, resin, and stone.

14. The flag holder of claim 12, wherein the design is a commemorative or memorial design.

15. The flag holder of claim 12, wherein the attaching portion is an adhesive.

16. The flag holder of claim 15, wherein the adhesive is selected from the group consisting of glue and double-stick adhesive.

17. A commemorative memorial flag holder comprising:
a base portion in a disc-shape, having a front side, a rear side, a top side and a bottom side, wherein the top side defines a hole that holds a flag when in use;
a design located on the front side of the base portion; and
a stand portion on the bottom side of the base portion.

18. The flag holder of claim 17, wherein the base portion comprises a material selected
from the group consisting of ceramic, resin, and stone.

19. The flag holder of claim 17, wherein the design is a commemorative or memorial design.

20. The flag holder of claim 17, wherein the stand portion includes an adhesive selected from the group consisting of glue and double-stick adhesive.
